(19) United States
(12) Patent Application Publication
(10) Pub. No.: US 2024/0255835 A1
(43) Pub. Date: Aug. 1, 2024

(54) PROJECTION DEVICE

(71) Applicant: Coretronic Corporation, Hsin-Chu (TW)

(72) Inventors: Fan-Chieh Chang, Hsin-Chu (TW); Chen-Yi Hong, Hsin-Chu (TW)

(73) Assignee: Coretronic Corporation, Hsin-Chu (TW)

(21) Appl. No.: 18/418,374

(22) Filed: Jan. 22, 2024

(30) Foreign Application Priority Data
Jan. 30, 2023 (CN) 202310044545.1

(51) Int. Cl. G03B 21/14

(52) U.S. Cl. CPC G03B 21/142; G03B 21/145

(57) ABSTRACT

A projection device includes an illumination system providing an illumination light beam; an optical engine module disposed on a transmission path of the illumination light beam, and converting the illumination light beam into an image light beam; a lens module disposed on a transmission path of the image light beam, and projecting the image light beam out of the projection device; and an adjustment module including a moving plate, a guide element, a gearing element, and a driving element. The moving plate is disposed on the guide element. The guide element is connected to the gearing element. The driving element is configured to drive the gearing element, such that the guide element is linked with the moving plate to move between a first position and a second position. The illumination system, the optical engine module, and the lens module are disposed on the moving plate.

### CROSS-REFERENCE TO RELATED APPLICATION

This application claims the priority benefit of Chinese application no. 202310044545.1, filed on Jan. 30, 2023. The entirety of the above-mentioned patent application is hereby incorporated by reference herein and made a part of this specification.

### BACKGROUND

### Technical Field

The disclosure relates to an optical device. Particularly, the disclosure relates to a projection device.

### Description of Related Art

At present, since an ultra-short-throw projection device can provide a fixed projection size only, the flexibility and versatility of use of the ultra-short-throw projection device are greatly reduced.

The information disclosed in this Background section is only for enhancement of understanding of the background of the described technology and as a result it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device, which may move projection to enlarge (zoom in) and reduce (zoom out) the projection size, and has better flexibility and versatility of use.

Other purposes and advantages of the disclosure may be further understood from the technical features of the disclosure.

To achieve one, some, or all of the above purposes or other purposes, an embodiment of the disclosure proposes a projection device, which includes an illumination system, an optical engine module, a lens module, and an adjustment module. The illumination system is configured to provide an illumination light beam. The optical engine module is disposed on a transmission path of the illumination light beam, and configured to convert the illumination light beam into an image light beam. The lens module is disposed on a transmission path of the image light beam, and configured to project the image light beam out of the projection device. The adjustment module includes a moving plate, a guide element, a gearing element, and a driving element. The moving plate is disposed on the guide element. The guide element is connected to the gearing element. The driving element is configured to drive the gearing element, such that the guide element is linked with the moving plate to move between a first position and a second position. The illumination system, the optical engine module, and the lens module are disposed on the moving plate.

In an embodiment of the disclosure, the guide element includes a linear sleeve, and the moving plate is disposed on the linear sleeve.

In an embodiment of the disclosure, the guide element further includes a sliding rod and a fixing element. Two ends of the sliding rod are fixed to the fixing element. The linear sleeve is sleeved on the sliding rod, and the linear sleeve moves along the sliding rod.

In an embodiment of the disclosure, the driving element includes a stepper motor or a linear motor.

In an embodiment of the disclosure, the gearing element includes a belt, a gear, a gear rack, a screw rod, a steel wire, or a combination of the above components.

In an embodiment of the disclosure, the projection device further includes a casing. The illumination system, the optical engine module, and the adjustment module are located within the casing. The lens module is located within the casing when the moving plate is located at the first position. The lens module protrudes out of the casing when the moving plate moves to the second position.

In an embodiment of the disclosure, the projection device further includes a sliding cover assembly, slidably disposed on the casing. The sliding cover assembly is adapted to slide between a third position and a fourth position. The sliding cover assembly shields the lens module when the sliding cover assembly is located at the third position. At least part of the lens module is exposed when the sliding cover assembly is located at the fourth position.

In an embodiment of the disclosure, the sliding cover assembly is located within a range from the third position to the fourth position when the moving plate is located at the first position.

In an embodiment of the disclosure, the sliding cover assembly includes a cover, two slide rails, a gear rack, and a sliding cover driving element. The cover has a top surface and two opposite side surfaces connected to the top surface. The two slide rails are respectively disposed on the two side surfaces of the cover. The gear rack is disposed on the top surface of the cover. An extension direction of the gear rack is the same as a sliding direction of the sliding cover assembly. The sliding cover driving element is configured to drive the gear rack, such that the cover slides between the third position and the fourth position relative to the casing along the two slide rails.

In an embodiment of the disclosure, the sliding cover assembly further includes an auxiliary slide rail, disposed on the top surface of the cover. An arrangement direction of the auxiliary slide rail is the same as the extension direction of the gear rack. The cover slides relative to the casing along the auxiliary slide rail.

In an embodiment of the disclosure, the lens module includes an ultra-short lens.

In an embodiment of the disclosure, the adjustment module further includes a sensor, configured to sense a position of the moving plate.

Based on the foregoing, the embodiment of the disclosure has at least one of the following advantages or effects. In the design of the projection device of the disclosure, the illumination system, the optical engine module, and the lens module are disposed on the moving plate of the adjustment module, and the driving element of the adjustment module drives the gearing element, such that the guide element is linked with the moving plate to move between the first position and the second position. In other words, when the moving plate moves, the illumination system, the optical engine module, and the lens module disposed thereon also move together, accordingly enlarging or reducing the projection size. As a result, the projection device of the disclosure has a non-fixed projection size, may enlarge or reduce the projection size, and has better flexibility and breadth of use.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2A is a schematic perspective view of the projection device of FIG. 1.

FIG. 2B is a schematic perspective view of the projection device of FIG. 1 when enlarging the projection size.

FIG. 3A is a schematic perspective view of an adjustment module at a first position according to another embodiment of the disclosure.

FIG. 3B is a schematic perspective view of the adjustment module of FIG. 3A at a second position.

FIG. 4A is a schematic perspective view of a projection device according to another embodiment of the disclosure.

FIG. 4B is a schematic perspective view of the projection device of FIG. 4A when opening a sliding cover assembly.

FIG. 4C is a schematic perspective view of the projection device of FIG. 4B when enlarging the projection size.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. As a result, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

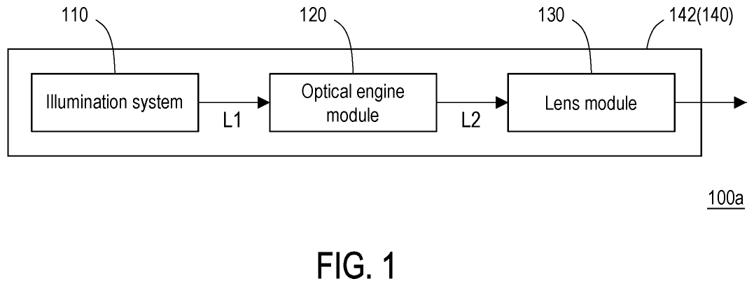

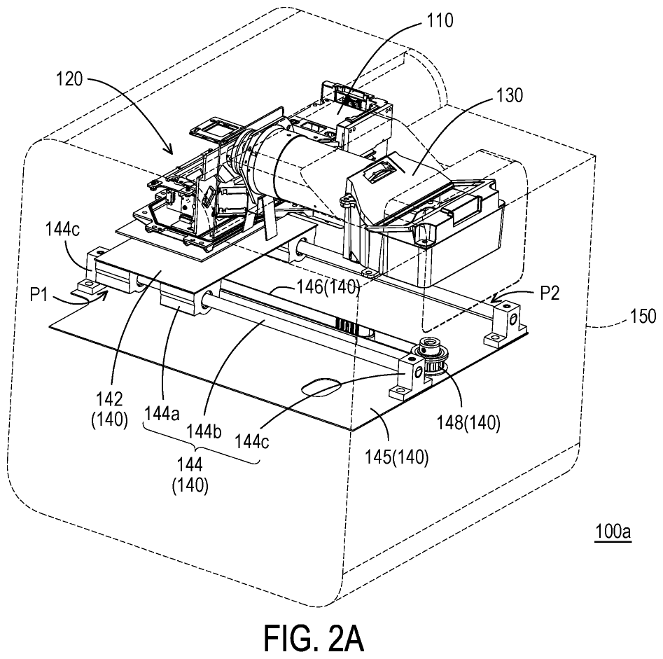

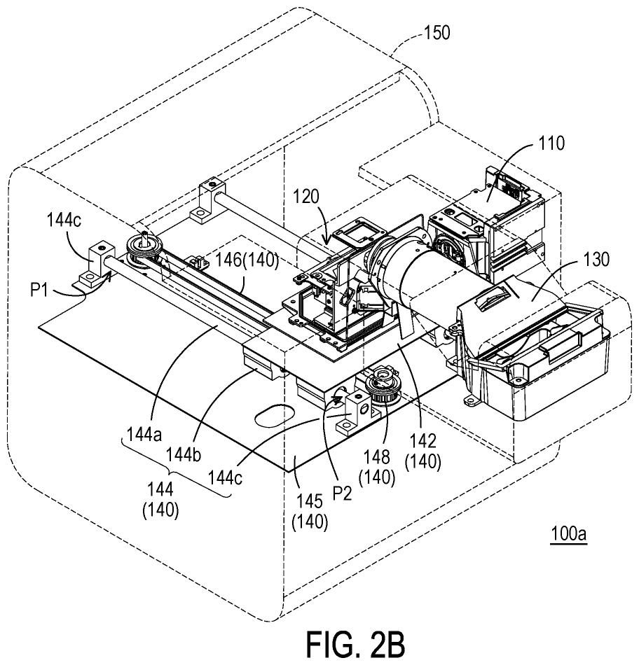

FIG. 1 is a schematic view of a projection device according to an embodiment of the disclosure. FIG. 2A is a schematic perspective view of the projection device of FIG. 1. FIG. 2B is a schematic perspective view of the projection device of FIG. 1 when enlarging the projection size. For clarity of description, a casing 150 is represented with broken lines in FIG. 2A and FIG. 2B.

First, with reference to FIG. 1, in this embodiment, a projection device 100a includes an illumination system 110, an optical engine module 120, a lens module 130, and an adjustment module 140. The illumination system 110 is configured to provide an illumination light beam L1. The optical engine module 120 is disposed on a transmission path of the illumination light beam L1, and configured to convert the illumination light beam L1 into an image light beam L2. The lens module 130 is disposed on a transmission path of the image light beam L2, and configured to project the image light beam L2 out of the projection device 100a. The illumination system 110, the optical engine module 120, and the lens module 130 are disposed on a moving plate 142 of the adjustment module 140.

The illumination system 110 of this embodiment includes an excitation light source. For example, the excitation light source includes a light-emitting diode (LED), a laser diode (LD), or a combination thereof. The illumination system 110 may further include a wavelength conversion element (for example, phosphor wheel), a light uniforming element (for example, rod), a filter element (for example, filter wheel), and at least one light guide element (for example, mirror, dichroic mirror, etc.). The illumination system 110 is configured to provide light beams of different wavelengths as a source of the illumination light beam L1. The light sources that meet the volume requirements in the actual design may each be implemented, and the type or form of the illumination system 110 is not specifically limited by the disclosure.

The optical engine module 120 of this embodiment includes a light valve. For example, the light valve is a spatial light modulator, such as a digital micro-mirror device (DMD), a liquid-crystal-on-silicon panel (LCOS Panel), or a liquid crystal panel (LCD). The lens module 130 includes, for example, one optical lens element or a combination of optical lens elements having refracting power, for example, including various combinations of non-planar lenses, such as a bi-concave lens element, a bi-convex lens element, a concave-convex lens element, a convex-concave lens element, a plano-convex lens element, and a plano-concave lens element. In an embodiment, the lens module 130 may also include a planar optical lens element to project the image light beam L2 from the optical engine module 120 out of the projection device 100a by reflection or transmission. The lens module 130 of this embodiment is embodied as an ultra-short lens.

Please refer to FIG. 2A and FIG. 2B together, in this embodiment, the adjustment module 140 includes a moving plate 142, a guide element 144, a gearing element 146, and a driving element 148. The moving plate 142 is disposed on the guide element 144. The guide element 144 is mechanically connected to the gearing element 146. The driving element 148 is configured to drive the gearing element 146, such that the guide element 144 is linked with the moving plate 142 to move between a first position P1 and a second position P2. The illumination system 110, the optical engine module 120, and the lens module 130 are disposed on the moving plate 142.

In this embodiment, the guide element 144 includes a linear sleeve 144a. The moving plate 142 is disposed on the linear sleeve 144a. The moving plate 142 is locked or fixed to the linear sleeve 144a. The guide element 144 may further include a sliding rod 144b and a fixing element 144c. Two ends of the sliding rod 144b are fixed to the fixing element 144c. The fixing element 144c includes a fastener, a screw, a screw hole, a hole for configuring one end of sliding rod 144b, for example. The linear sleeve 144a is sleeved on the sliding rod 144b. The linear sleeve 144a moves along the sliding rod 144b, that is, moves linearly. The guide element 144 further includes a base 145, and the driving element 148 and the fixing element 144c are disposed on the base 145. In an embodiment, the gearing element 146 is a belt, a gear, a gear rack, a screw rod, a steel wire, or a combination of the above components, for example. In FIG. 2A, the gearing element 146 is embodied as a belt. The driving element 148 drives the belt, such that the belt drives the linear sleeve 144a to move linearly. In an embodiment, the driving element 148 is a stepper motor or a linear motor, for example. The moving plate 142 is a plate. The projection device 100a of this embodiment further includes a casing 150. The illumination system 110, the optical engine module 120, and the adjustment module 140 are located within the casing 150.

As shown in FIG. 2A, the lens module 130 is located within the casing 150 when the moving plate 142 is located at the first position P1. At this time, if the projection device 100a is turned on, the projection device 100a may directly project to present the original projection size. As shown in FIG. 2B, the lens module 130 may protrude out of the casing 150 when the moving plate 142 moves to the second position P2, such that the projection size of the projection device 100a is enlarged. With reference to FIG. 2B and FIG. 2A together, the lens module 130 moves back into the casing 150 when the moving plate 142 moves back from the second position P2 to the first position P1, such that the projection size of the projection device 100a is changed and zooms out from the enlarged size to the original projection size. The moving plate 142 has a first side away from the lens module 130 and a second side close to the lens module 130. The first side of the moving plate 142 is located at the first position P1 when the projection size of the projection device 100a is the original projection size. The second side of the moving plate 142 is located at the second position P2 when the projection size of the projection device 100a is the enlarged size. The first position P1 and the second position P2 are respectively adjacent to two ends of the sliding rod 144b.

In brief, since the illumination system 110, the optical engine module 120, and the lens module 130 of this embodiment are disposed on the moving plate 142 of the adjustment module 140, the driving element 148 of the adjustment module 140 drives the gearing element 146, such that the moving plate 142 may move between the first position P1 and the second position P2. In other words, when the moving plate 142 moves, the illumination system 110, the optical engine module 120, and the lens module 130 disposed on the moving plate 142 also move together, accordingly enlarging or reducing the projection size. As a result, the projection device 100a of this embodiment has a non-fixed projection size, may enlarge or reduce the projection size, and has better flexibility and breadth of use.

Other embodiments are identified below for description. The reference numerals and part of contents of the above embodiments remain to be used in the following embodiments, where the same reference numerals are adopted to denote the same or similar elements, and description of the same technical content is omitted. Reference may be made to the above embodiments for the description of the omitted part, which will not be repeated in the following embodiments.

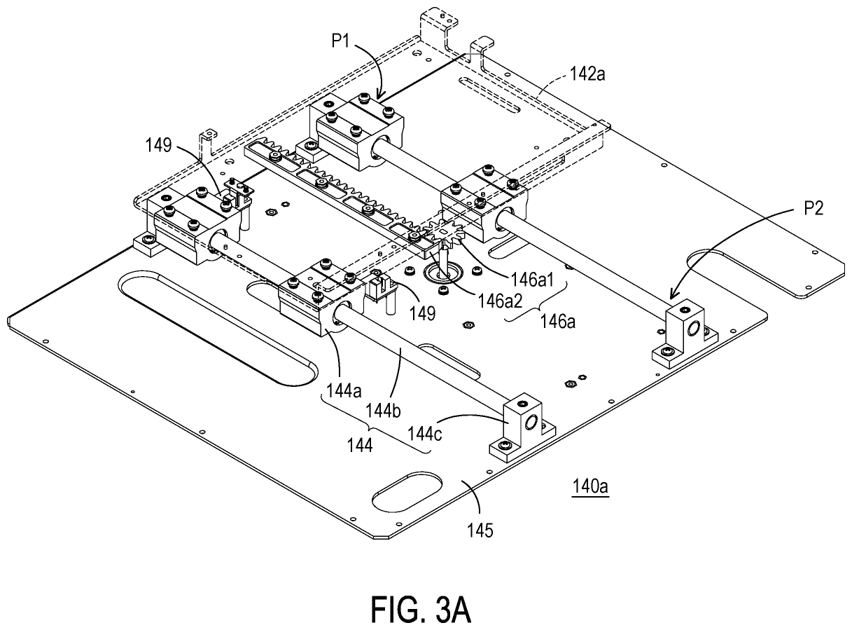

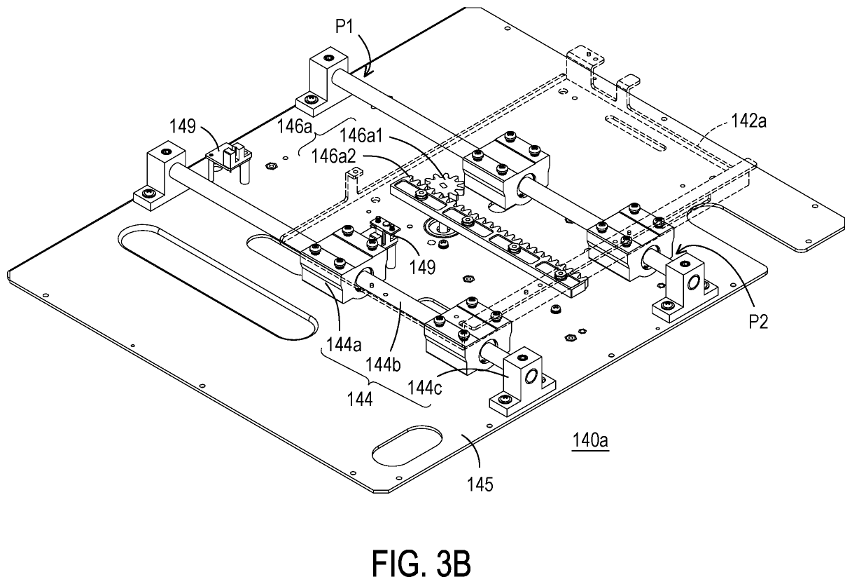

FIG. 3A is a schematic perspective view of an adjustment module at a first position according to another embodiment of the disclosure. FIG. 3B is a schematic perspective view of the adjustment module of FIG. 3A at a second position. For clarity of description, a moving plate 142a is represented with broken lines in FIG. 3A and FIG. 3B.

With reference to FIG. 2A, FIG. 2B, FIG. 3A, and FIG. 3B together, an adjustment module 140a of this embodiment is similar to the adjustment module 140 in FIG. 2A, while their main differences are: in this embodiment, a gearing element 146a of the adjustment module 140a is embodied as a combination of a gear 146a1 and a gear rack 146a2. Through the combination of the gear 146a1 and the gear rack 146a2, the moving plate 142a linked with the guide element 144 may move between the first position P1 and the second position P2. The driving element 148 (shown in FIG. 2A) is connected to the gear 146a1 to drive the gear 146a1 to rotate, and the gear 146a1 drives the gear rack 146a2, such that the gear rack 146a2 drives the linear sleeve 144a to move linearly. The adjustment module 140a of this embodiment further includes a sensor 149, disposed in the casing 150. The sensor 149 is configured to sense a position of the moving plate 142a.

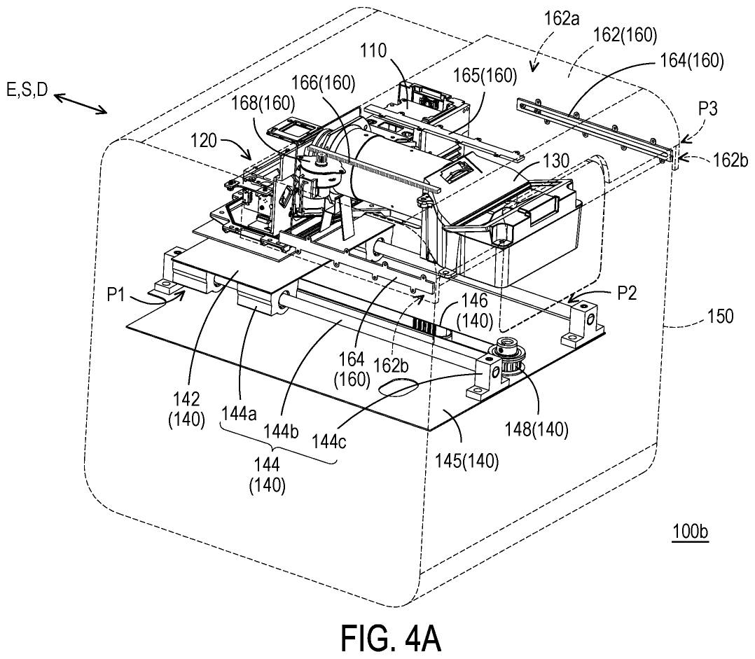

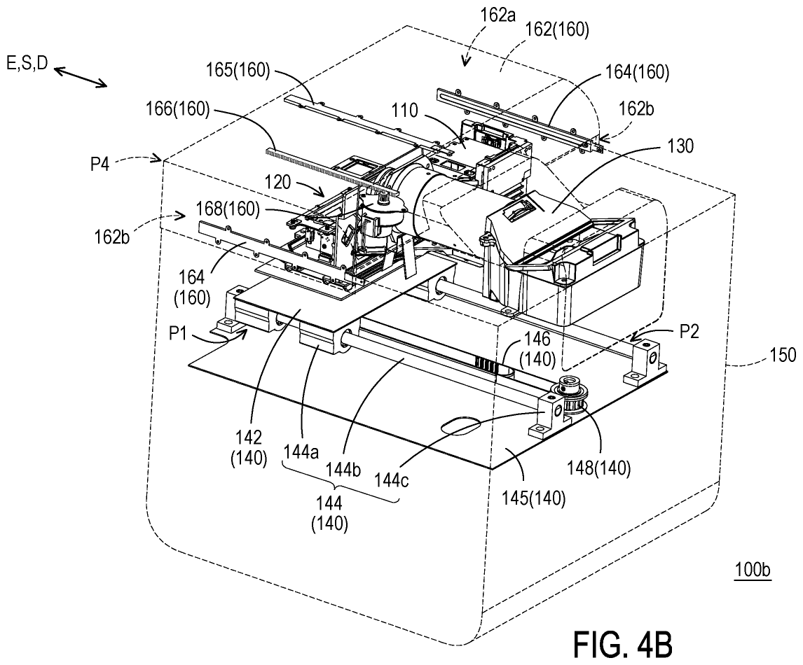

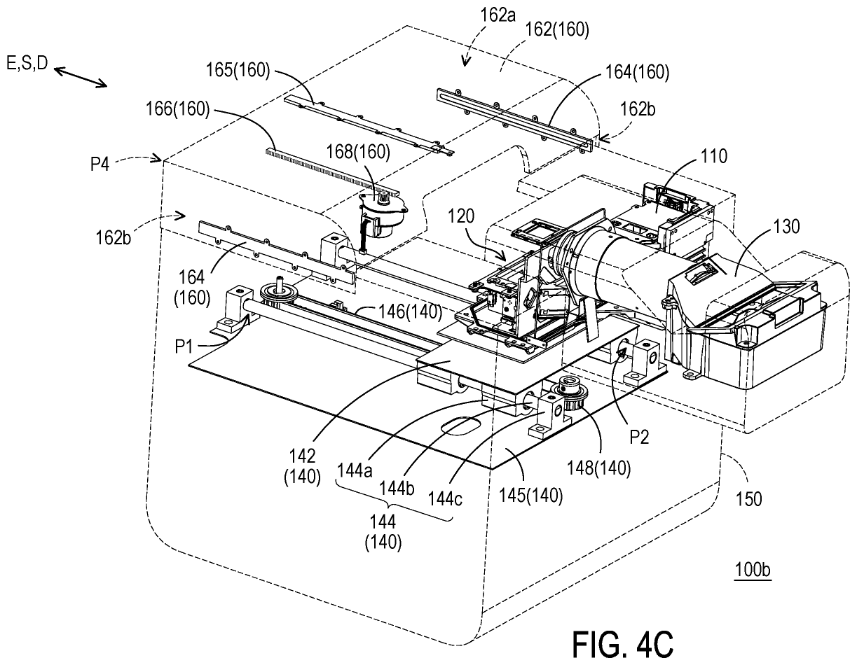

FIG. 4A is a schematic perspective view of a projection device according to another embodiment of the disclosure. FIG. 4B is a schematic perspective view of the projection device of FIG. 4A when opening a sliding cover assembly. FIG. 4C is a schematic perspective view of the projection device of FIG. 4B when enlarging the projection size. For clarity of description, the casing 150 and a cover 162 of a sliding cover assembly 160 are represented with broken lines in FIG. 4A, FIG. 4B, and FIG. 4C.

First, with reference to FIG. 2A, FIG. 4A, and FIG. 4B together, a projection device 100b of this embodiment is similar to the projection device 100a in FIG. 2A, while their main differences are: in this embodiment, the projection device 100b further includes a sliding cover assembly 160, which is slidably disposed on the casing 150. The sliding cover assembly 160 is adapted to slide between a third position P3 and a fourth position P4.

In this embodiment, the sliding cover assembly 160 includes a cover 162, two slide rails 164, a gear rack 166, and a sliding cover driving element 168. The cover 162 has a top surface 162a and two opposite side surfaces 162b connected to the top surface 162a. The two slide rails 164 are respectively disposed on the two side surfaces 162b of the cover 162. The gear rack 166 is disposed on the top surface 162a of the cover 162. An extension direction E of the gear rack 166 is the same as a sliding direction S of the sliding cover assembly 160, the sliding direction S may be a direction from the third position P3 to the fourth position P4, or a direction from the fourth position P4 to the third position P3. The sliding cover driving element 168 is configured to drive the gear rack 166, such that the cover 162 slides between the third position P3 and the fourth position P4 relative to the casing 150 along the two slide rails 164. Here, the sliding cover driving element 168 is a motor gear, for example, which is not movable at a fixed position. The sliding cover driving element 168 is engaged with the gear rack 166 fixed to the cover 162, such that the cover 162 may slide linearly relative to the casing 150. The sliding cover assembly 160 further includes an auxiliary slide rail 165, which is disposed on the top surface 162a of the cover 162. The auxiliary slide rail 165 is a slide rail. An arrangement direction D of the auxiliary slide rail 165 is the same as the extension direction E of the gear rack 166, the arrangement direction D may be a direction from the third position P3 to the fourth position P4, or a direction from the fourth position P4 to the third position P3. The cover 162 slides relative to the casing 150 along the auxiliary slide rail 165.

As shown in FIG. 4A, the sliding cover assembly 160 shields the lens module 130 when the sliding cover assembly 160 is located at the third position P3 to prevent the lens module 130 from being exposed to the outside, which may reduce dust pollution to the lens module 130. As shown in FIG. 4B and FIG. 4C, at least part of the lens module 130 is exposed when the sliding cover assembly 160 is located at the fourth position P4, that is, when the sliding cover assembly 160 is opened, which may cause the lens module 130 (see FIG. 1) to project the image light beam L2 out of the projection device 100b.

With reference to FIG. 4A and FIG. 4B together, the sliding cover assembly 160 may be located within a range from the third position P3 to the fourth position P4 when the moving plate 142 of the adjustment module 140 is located at the first position P1. For example, if the sliding cover assembly 160 is located at the third position P3, the sliding cover assembly 160 shields the lens module 130, and the projection device 100b is in a standby or non-use state. If the sliding cover assembly 160 is located at the fourth position P4, the projection device 100b may directly project to present the original projection size. The sliding cover assembly 160 has a first side close to the lens module 130 and a second side away from the lens module 130. The first side of the sliding cover assembly 160 is located at the third position P3 when the sliding cover assembly 160 is in a closed state. The second side of the sliding cover assembly 160 is located at the fourth position P4 when the sliding cover assembly 160 is in an opened state.

With reference to FIG. 4C, the sliding cover assembly 160 is located at the fourth position P4 when the moving plate 142 is located at the second position P2. At this time, since the lens module 130 may protrude out of the casing 150, the projection size of the projection device 100b is enlarged. With reference to FIG. 4C and FIG. 4B together, the lens module 130 moves back into the casing 150 when the moving plate 142 moves back from the second position P2 to the first position P1, such that the projection size of the projection device 100b is changed and zooms out from the enlarged size to the original projection size. Since the sliding cover assembly 160 is located at the fourth position P4, the image light beam L2 from the lens module 130 may be transmitted to the projection target instead of being shielded by the sliding cover assembly 160. In another embodiment, regardless of whether the sliding cover assembly 160 is located at the third position P3 or the fourth position P4, since the sliding cover assembly 160 does not shield the image light beam L2 from the lens module 130 when the moving plate 142 is located at the second position P2, the sliding cover assembly 160 may be located at any position between the third position P3 and the fourth position P4 when the moving plate 142 is located at the second position P2.

In brief, when the moving plate 142 moves, the illumination system 110, the optical engine module 120, and the lens module 130 disposed thereon also move together, accordingly enlarging or reducing the projection size. As a result, the projection device 100b of this embodiment has a non-fixed projection size, may enlarge (zoom in) or reduce (zoom out) the projection size, and has better flexibility and breadth of use. The projection device 100b of this embodiment further includes the sliding cover assembly 160 that may shield the lens module 130 or expose a part of the lens module 130 for projection, which may prevent the lens module 130 from being exposed to the outside in a standby or non-use state, and may reduce dust pollution to the lens module 130.

In summary of the foregoing, the embodiment of the disclosure has at least one of the following advantages or effects. In the design of the projection device of the disclosure, the illumination system, the optical engine module, and the lens module are disposed on the moving plate of the adjustment module, and the driving element of the adjustment module drives the gearing element, such that the guide element is linked with the moving plate to move between the first position and the second position. In other words, when the moving plate moves, the illumination system, the optical engine module, and the lens module disposed thereon also move together, accordingly enlarging or reducing the projection size. As a result, the projection device of the disclosure has a non-fixed projection size, may enlarge or reduce the projection size, and has better flexibility and breadth of use.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. As a result, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
an illumination system, configured to provide an illumination light beam;
an optical engine module, disposed on a transmission path of the illumination light beam, and configured to convert the illumination light beam into an image light beam;
a lens module, disposed on a transmission path of the image light beam, and configured to project the image light beam out of the projection device; and
an adjustment module, comprising a moving plate, a guide element, a gearing element, and a driving element, wherein the moving plate is disposed on the guide element, the guide element is connected to the gearing element, the driving element is configured to drive the gearing element, such that the guide element is linked with the moving plate to move between a first position and a second position, and the illumination system, the optical engine module, and the lens module are disposed on the moving plate.

2. The projection device according to claim 1, wherein the guide element comprises a linear sleeve, and the moving plate is disposed on the linear sleeve.

3. The projection device according to claim 2, wherein the guide element further comprises a sliding rod and a fixing element, wherein two ends of the sliding rod are fixed to the fixing element, the linear sleeve is sleeved on the sliding rod, and the linear sleeve moves along the sliding rod.

4. The projection device according to claim 1, wherein the driving element comprises a stepper motor or a linear motor.

5. The projection device according to claim 1, wherein the gearing element comprises a belt, a gear, a gear rack, a screw rod, a steel wire, or a combination of the above components.

6. The projection device according to claim 1, further comprising:
a casing, wherein the illumination system, the optical engine module, and the adjustment module are located within the casing, wherein the lens module is located within the casing when the moving plate is located at the first position, and the lens module protrudes out of the casing when the moving plate moves to the second position.

7. The projection device according to claim 6, further comprising:
a sliding cover assembly, slidably disposed on the casing, wherein the sliding cover assembly is adapted to slide between a third position and a fourth position, wherein the sliding cover assembly shields the lens module when the sliding cover assembly is located at the third position, and at least part of the lens module is exposed when the sliding cover assembly is located at the fourth position.

8. The projection device according to claim 7, wherein the sliding cover assembly is located within a range from the third position to the fourth position when the moving plate is located at the first position.

9. The projection device according to claim 7, wherein the sliding cover assembly comprises:
a cover, having a top surface and two opposite side surfaces connected to the top surface;
two slide rails, respectively disposed on the two side surfaces of the cover;
a gear rack, disposed on the top surface of the cover, wherein an extension direction of the gear rack is the same as a sliding direction of the sliding cover assembly; and
a sliding cover driving element, configured to drive the gear rack, such that the cover slides between the third position and the fourth position relative to the casing along the two slide rails.

10. The projection device according to claim 9, wherein the sliding cover assembly further comprises:
an auxiliary slide rail, disposed on the top surface of the cover, wherein an arrangement direction of the auxiliary slide rail is the same as the extension direction of the gear rack, and the cover slides relative to the casing along the auxiliary slide rail.

11. The projection device according to claim 1, wherein the lens module comprises an ultra-short lens.

12. The projection device according to claim 1, wherein the adjustment module further comprises a sensor, configured to sense a position of the moving plate.
